(19) United States
(12) Patent Application Publication
(10) Pub. No.: US 2025/0286251 A1
(43) Pub. Date: Sep. 11, 2025

(54) Anti-Theft System for Lithium Batteries in Golf Carts

(71) Applicant: Michael McDonald, Charlotte, NC (US)

(72) Inventor: Michael McDonald, Charlotte, NC (US)

(21) Appl. No.: 19/073,127

(22) Filed: Mar. 7, 2025

Related U.S. Application Data
(60) Provisional application No. 63/562,692, filed on Mar. 7, 2024.

(51) Int. Cl. H01M 50/576; B60R 25/33; B60R 25/34; H01M 10/42

(52) U.S. Cl. CPC H01M 50/576; B60R 25/33; B60R 25/34; H01M 10/425; B60R 2325/108; B60Y 2200/23; H01M 2010/4278

(57) ABSTRACT

The invention provides an anti-theft system for lithium batteries in golf carts, comprising an integrated hardware module that selectively enables or disables power output from the battery. A mobile application on a user device communicates with the anti-theft hardware through secure encrypted protocols. When activated, the system interrupts the power path between battery cells and output terminals, rendering the battery inoperable during unauthorized use attempts. The system incorporates tamper detection sensors that monitor physical interference and automatically alert users via the mobile application. Authentication mechanisms include biometric verification, passwords, and personal identification numbers to ensure only authorized users can control the functionality. Additional features include geographic boundary detection that automatically activates protection when the user device moves beyond a predetermined distance from the battery, real-time status monitoring, and comprehensive event logging for security auditing. The system provides effective protection against theft while maintaining user convenience.

### FIELD OF THE DISCLOSURE

This invention relates to anti-theft systems for lithium batteries, particularly those utilized in golf carts and similar electric vehicles. More specifically, it pertains to integrated hardware-software solutions that enable remote activation and deactivation of power output functionality through secure mobile applications, thereby preventing unauthorized use and theft of valuable lithium battery systems in recreational and commercial electric vehicles.

### BACKGROUND OF THE INVENTION

The recreational vehicle industry, particularly the golf cart segment, has witnessed significant technological evolution over the past decade. Traditional lead-acid batteries, which have powered golf carts since their inception, are increasingly being replaced by advanced lithium-ion battery systems. This transition is driven by the superior performance characteristics of lithium batteries, including higher energy density, longer cycle life, reduced weight, and faster charging capabilities.

Golf carts equipped with lithium batteries have gained substantial popularity in golf courses, retirement communities, resort properties, and various recreational settings. The market value of these lithium battery systems often exceeds several thousand dollars per unit, making them attractive targets for theft. Unlike lead-acid batteries, lithium batteries maintain their value over longer periods and can be easily repurposed for various applications, further increasing their appeal to potential thieves.

The increasing incidents of golf cart theft, particularly those targeting the valuable lithium battery components, have created significant financial losses for both individual owners and fleet operators. Insurance claims related to golf cart theft have risen dramatically in recent years, with specialized lithium battery theft accounting for a disproportionate percentage of these claims. Traditional physical security measures such as chains, locks, and storage facilities have proven inadequate against determined thieves who often possess specialized knowledge about these vehicles.

Prior art in the field of vehicle anti-theft systems primarily focused on conventional automobiles, with adaptations for golf carts limited to alarm systems, GPS tracking, and steering wheel locks. These solutions were designed when golf carts contained relatively low-value components and were predominantly powered by lead-acid batteries. Consequently, they fail to address the specific vulnerabilities associated with high-value lithium battery systems.

Existing electronic immobilization systems for vehicles typically interrupt the ignition or starter circuits. However, these approaches are insufficient for protecting detachable or easily accessible battery systems that can be removed and utilized independently of the vehicle. Additionally, conventional anti-theft systems for electric vehicles generally target the controller or motor components rather than the power source itself.

Mobile technology and Internet of Things (IoT) advancements have enabled remote monitoring and control of various devices through smartphone applications. These technologies have been implemented in home security systems, automobile security, and even traditional power tools, but their application to lithium battery protection in recreational vehicles remains underdeveloped. While remote disabling technologies exist for cellular-connected automotive applications, they typically require expensive cellular subscriptions and complex infrastructure that is impractical for the golf cart market.

The gap in current technology lies in the absence of an integrated, cost-effective solution that combines physical battery protection with remote control capabilities specifically designed for the unique characteristics of lithium batteries in golf carts. Existing solutions either focus exclusively on the vehicle itself, neglecting the battery as the primary theft target, or require complex infrastructure that is economically unfeasible for widespread adoption in the recreational vehicle market.

Furthermore, the technical challenge involves creating a system that can effectively disable a lithium battery without causing damage to its sensitive electronic components or compromising safety, while simultaneously being resistant to tampering and unauthorized override attempts.

The object of the present invention is therefore to provide an anti-theft system specifically designed for lithium batteries used in golf carts that addresses these technological gaps. The invention aims to create an integrated hardware-software solution that enables secure remote activation and deactivation of the battery's functionality through a user-friendly mobile application, effectively rendering the battery inoperable when activated while being resistant to tampering attempts. Additionally, the invention seeks to accomplish this protection without requiring complex infrastructure or ongoing subscription costs, making it economically viable for widespread adoption across individual owners and fleet operators in the recreational vehicle market.

### SUMMARY OF THE INVENTION

In some aspects, the present invention provides an anti-theft system for lithium batteries used in golf carts, comprising an integrated hardware module capable of selectively enabling or disabling power output from the battery upon receiving authenticated commands.

Some embodiments describe a mobile application executable on a user device that establishes secure communication with the anti-theft hardware module integrated within the lithium battery, enabling remote control of the battery's functionality.

In further aspects, the invention incorporates a controller communicatively coupled to the anti-theft hardware that processes activation and deactivation commands received from the mobile application and authenticates these commands before implementation.

Other aspects include authentication mechanisms that verify user credentials against stored authentication data, including biometric verification performed through the mobile application interface to ensure only authorized users can control the anti-theft functionality.

In yet further aspects, the anti-theft hardware module comprises a switching circuit that physically interrupts the power path between battery cells and output terminals when the anti-theft mode is enabled, effectively rendering the battery unusable when stolen.

Some embodiments describe tamper detection capabilities through sensors integrated within the anti-theft hardware module, which monitor for unauthorized physical interference with the lithium battery.

In additional aspects, the system maintains a comprehensive log of activation events, deactivation events, and tampering detection events, providing a forensic trail of all interactions with the anti-theft system.

Further aspects include real-time status monitoring capabilities, where the mobile application displays current information regarding the anti-theft mode and overall battery condition to the user.

In some implementations, the system establishes secure encrypted communication channels between the mobile application and the anti-theft hardware module to prevent interception or spoofing of commands.

Even further aspects describe a method for preventing unauthorized use that includes authenticating users, processing activation commands, verifying command authenticity, and disabling power output upon successful verification.

Some embodiments implement geographic boundary functionality, automatically activating the anti-theft mode when the user device moves beyond a predetermined distance from the lithium battery, providing passive protection without user intervention.

Other aspects include periodic connectivity verification between the mobile application and the anti-theft module, with automated alerts generated when connectivity is lost, potentially indicating theft or tampering.

In further aspects, the anti-theft system monitors multiple battery parameters including voltage, current, temperature, and physical orientation to detect sophisticated tampering attempts that might not trigger conventional sensors.

Some implementations include a computer program product embodied on a non-transitory computer-readable medium that executes the control logic for the anti-theft system, processing commands and monitoring sensor data.

Other aspects describe wireless communication capabilities that allow for flexible deployment across various golf cart models and lithium battery configurations without requiring extensive modification to existing hardware.

In additional aspects, the system incorporates multiple authentication factors, combining passwords, personal identification numbers, and biometric identifiers to create layered security that is highly resistant to unauthorized access.

Further aspects include a user-friendly interface within the mobile application that simplifies the process of activating and deactivating the anti-theft mode while providing clear visibility into system status and security events.

### BRIEF DESCRIPTION OF THE DRAWINGS

The accompanying drawings, which are incorporated in and constitute a part of this specification, illustrate embodiments of the invention and, together with the description, serve to explain the principles of the invention. In the drawings:

FIG. 1 illustrates a golf cart incorporating the anti-theft system according to an exemplary embodiment of the present invention.

FIG. 2 shows the main components of the anti-theft system including the battery pack, controller, connecting pins, wiring, and motor.

FIG. 3 depicts the power control module, network module, controller, and battery pack components of the anti-theft system.

FIG. 4 is a system illustration showing the interaction between a user, user device, network, and golf cart in the anti-theft system.

FIG. 5 shows a user device operating interface with the anti-theft toggle in the “on” position.

FIG. 6 shows a user device operating interface with the anti-theft toggle in the “off” position.

FIG. 7 is a flowchart illustrating the process for activating the anti-theft mode for lithium batteries in golf carts.

FIG. 8 is a flowchart illustrating the process for deactivating the anti-theft mode for lithium batteries in golf carts.

### DETAILED DESCRIPTION OF PREFERRED EMBODIMENTS

The following description of preferred embodiments refers to the accompanying drawings, which illustrate specific embodiments of the invention. Other embodiments having different structures and operations do not depart from the scope of the present invention. The same reference numbers may be used in the drawings and the following description to refer to the same or like parts.

As used herein, the terms “comprising,” “including,” “containing,” “characterized by,” and grammatical equivalents thereof are inclusive or open-ended and do not exclude additional, unrecited elements or method steps, unless otherwise stated. Other than in the operating examples, or where otherwise indicated, all numbers expressing quantities, processing parameters, assessment scores, and so forth used in the specification and claims are to be understood as being modified in all instances by the term “about,” meaning within a reasonable range of the indicated value. The terms “a” and “an” refer to one or more of the elements described, whereas the term “plurality” refers to two or more of the elements described, unless the context clearly indicates otherwise.

The Anti-Theft System for Lithium Batteries in Golf Carts described herein provides novel solutions for preventing unauthorized use and theft of valuable lithium battery systems. The invention incorporates advanced hardware components, secure communication protocols, and mobile application technology to enable remote activation and deactivation of the battery's functionality. The following detailed description, along with the accompanying drawings, provides a comprehensive understanding of the various embodiments and aspects of the invention.

This invention addresses the challenges of protecting high-value lithium batteries used in golf carts and similar electric vehicles in an effective and user-friendly manner. By leveraging secure mobile application technology integrated with specialized anti-theft hardware, the invention enables owners to remotely disable their battery systems, thereby deterring theft and unauthorized use. The system and method further integrate tamper detection capabilities and encrypted communication protocols to enhance the security and reliability of the anti-theft functionality for recreational and commercial electric vehicle applications.

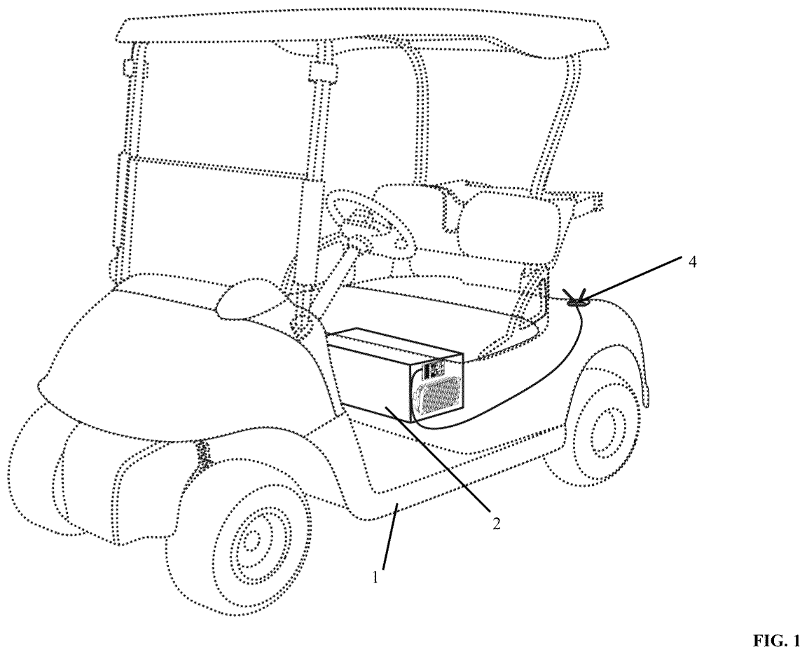

Firstly, the FIG. 1 illustrates a golf cart according to an exemplary embodiment of the anti-theft system for lithium batteries. The golf cart (1) is shown in a side perspective view, highlighting the key components of the invention. The lithium battery (2) is positioned in the rear compartment of the golf cart, where it is typically installed to power the vehicle's electric motor. The battery (2) incorporates the integrated anti-theft hardware module, which includes the switching circuit and tamper detection sensors enclosed within the battery casing for protection against tampering attempts. The network module (4) is mounted adjacent to the battery and serves as the communication interface between the lithium battery's anti-theft hardware and external devices. This network module (4) houses the controller that processes authentication commands and manages the secure communication protocols. It contains the wireless transceiver that establishes connections with the user's mobile device running the anti-theft application. The positioning of the network module (4) ensures optimal signal transmission while remaining protected from environmental factors and unauthorized access. The configuration shown allows for retrofitting existing golf carts with the anti-theft system without requiring significant modifications to the vehicle's structure, making it suitable for both new installations and aftermarket upgrades.

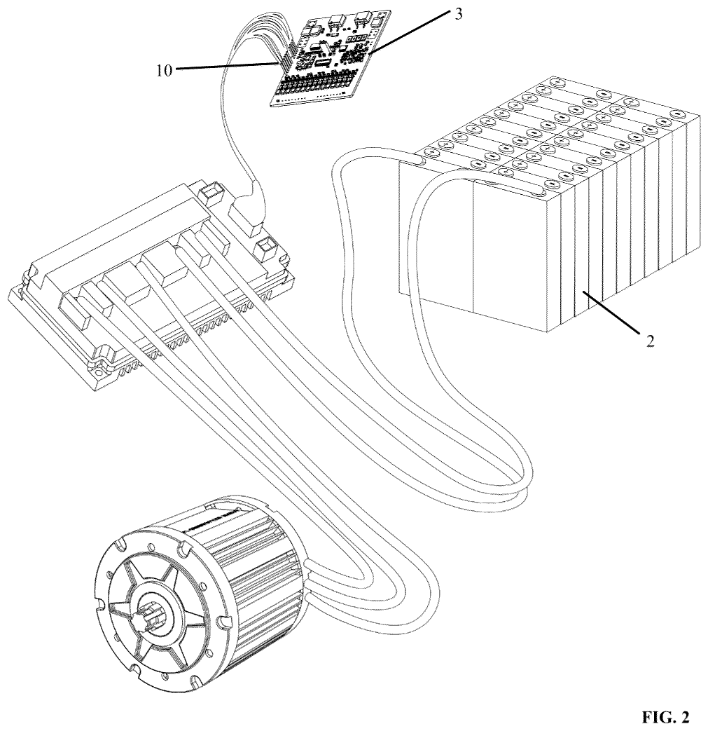

On the other hand, the FIG. 2 depicts the main components of the anti-theft system for lithium batteries in golf carts according to an exemplary embodiment. The battery pack (2) is shown in a partially exploded view to illustrate its integration with the anti-theft system. This lithium battery pack (2) comprises multiple lithium-ion cells arranged in series and parallel configurations to provide the necessary voltage and capacity for golf cart operation. The controller (3) is mounted directly on the battery pack (2) in a protected housing to prevent unauthorized access and tampering. This controller (3) contains the microprocessor that executes the authentication algorithms and manages the anti-theft functionality. The connecting pins (10) provide the electrical interface between the battery pack (2) and the golf cart's electrical system, including both power connections and data communication ports for the anti-theft system. These pins are designed with security features that prevent bypassing of the anti-theft mechanism. The wiring (20) illustrates the internal electrical connections between the battery cells, controller, and output terminals, with specific anti-theft circuits highlighted. This wiring (20) includes the power interruption circuits that are activated when the anti-theft mode is enabled. The motor (21) represents the golf cart's drive motor that receives power from the battery pack through the connecting pins and wiring when the anti-theft system is in the deactivated state. The arrangement of these components demonstrates how the anti-theft system is fully integrated within the battery pack's architecture, making separation or bypass of the security features extremely difficult without specialized knowledge and tools.

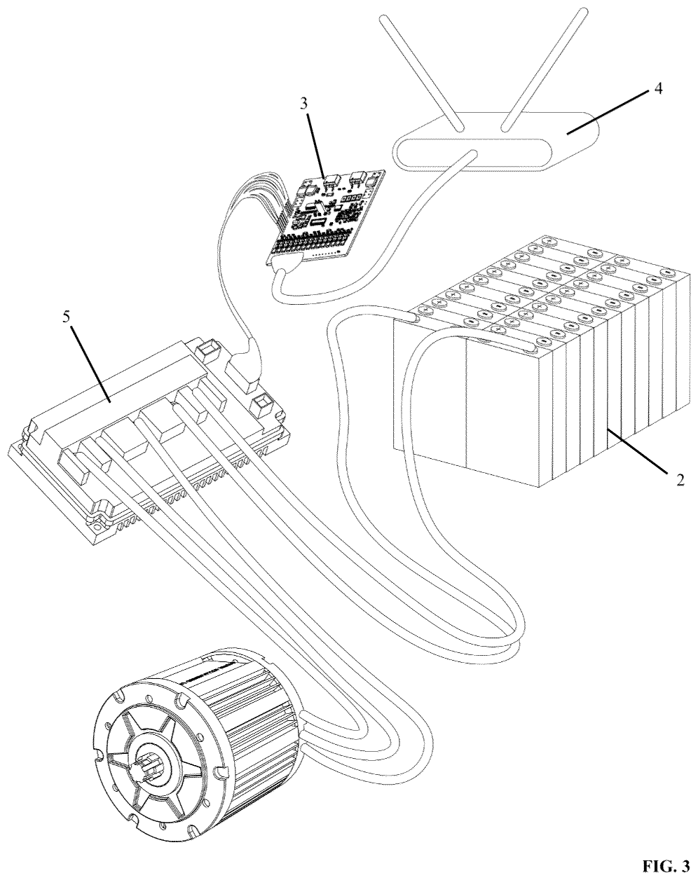

Further, the FIG. 3 provides a detailed functional view of the anti-theft system's core components and their interrelationships. The power control module (5) is prominently featured as the critical component that implements the power interruption functionality when the anti-theft mode is activated. This module (5) contains the electronic switching circuits that physically disconnect the power path between the battery cells and the output terminals, effectively rendering the battery inoperable when in the secured state. The network module (4) is shown connected to both the controller and the power control module, providing the wireless communication capabilities that enable remote operation of the anti-theft system. This network module (4) incorporates encryption processors and secure communication protocols to prevent unauthorized access to the system. The controller (3) is illustrated with connections to both the network module (4) and the power control module (5), highlighting its role as the central processing unit that contains the firmware instructions governing the operation of the entire anti-theft system. The controller (3) processes authentication requests, verifies credentials, and issues commands to the power control module based on authenticated user inputs. The battery pack (2) is shown with a modular design that can accommodate various configurations of lithium battery cells, whether as a single large cell or as multiple smaller cells connected in series and parallel arrangements, demonstrating the flexibility of the anti-theft system to be implemented across different battery designs and capacities.

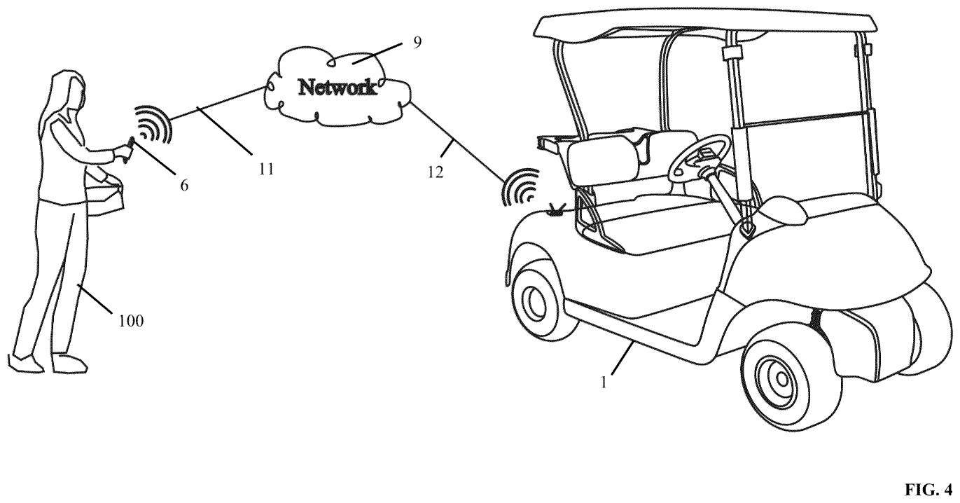

The non-limiting embodiment of FIG. 4 illustrates the complete system architecture of the anti-theft solution for lithium batteries in golf carts. The person or user (100) is shown interacting with the user device (6), which is typically a smartphone or tablet running the specialized anti-theft mobile application. This user device (6) provides the interface through which the user can control all anti-theft features, including activation, deactivation, status monitoring, and alert reception. The network (9) is depicted as the communication infrastructure that facilitates secure data exchange between the user device and the golf cart. This network may utilize Bluetooth, Wi-Fi, cellular, or other wireless protocols depending on the implementation. The communication from device (11) represents the outgoing data stream containing encrypted commands and authentication information sent from the user device. Correspondingly, the communication to cart (12) shows the incoming data received by the golf cart's network module. The cart (1) is shown with the integrated lithium battery and anti-theft hardware, completing the end-to-end security system that protects the valuable battery from unauthorized use or theft.

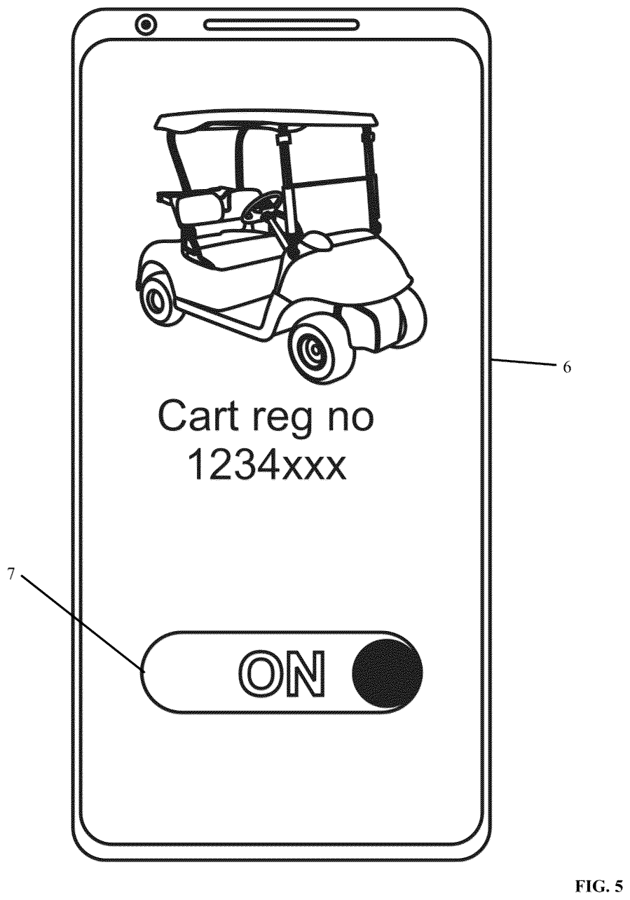

On the other hand, FIG. 5 depicts the user interface of the anti-theft mobile application in the activated state. The user device (6) displays the application's main control screen featuring the prominent toggle switch in the “on” position (7). This toggle on (7) state is visually emphasized with a green color and lock icon, clearly indicating that the anti-theft system is currently active. The interface shows additional status information including battery charge level, connection strength to the golf cart, and the timestamp of when the anti-theft mode was activated. The screen also displays a confirmation message informing the user that the lithium battery's power output has been successfully disabled and the cart is secured against unauthorized use.

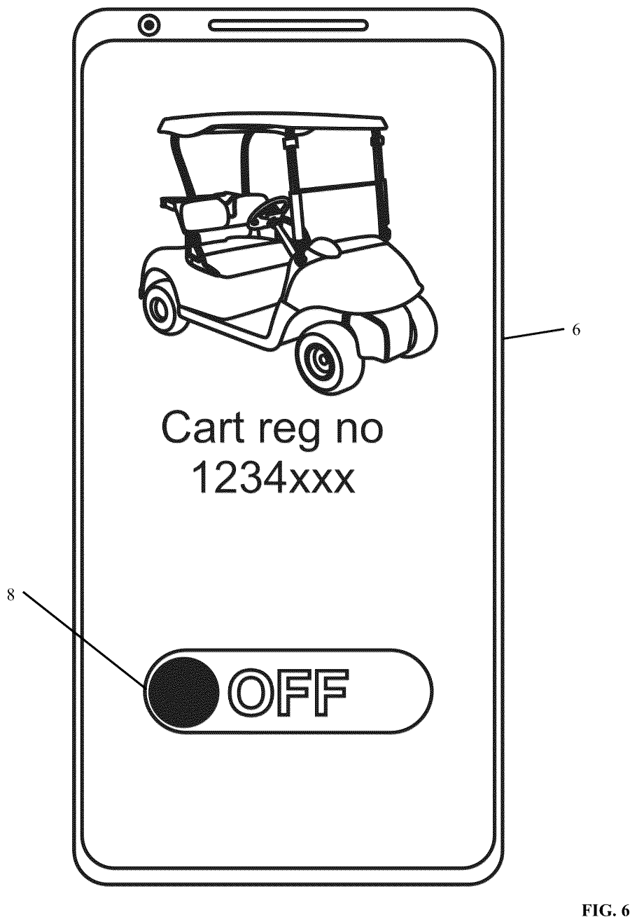

Further still, FIG. 6 illustrates the user interface of the anti-theft mobile application in the deactivated state. The user device (6) shows the same control screen but with the toggle switch now in the “off” position (8). This toggle off (8) state is visually differentiated with a gray color and unlocked icon, clearly indicating that the anti-theft protection is currently inactive. The interface displays updated status information confirming that the lithium battery is now operational and providing power to the golf cart. Additional information shown includes the duration for which the system was previously in the protected state and a message confirming successful authentication prior to deactivation, providing the user with verification that the security state change was properly authorized.

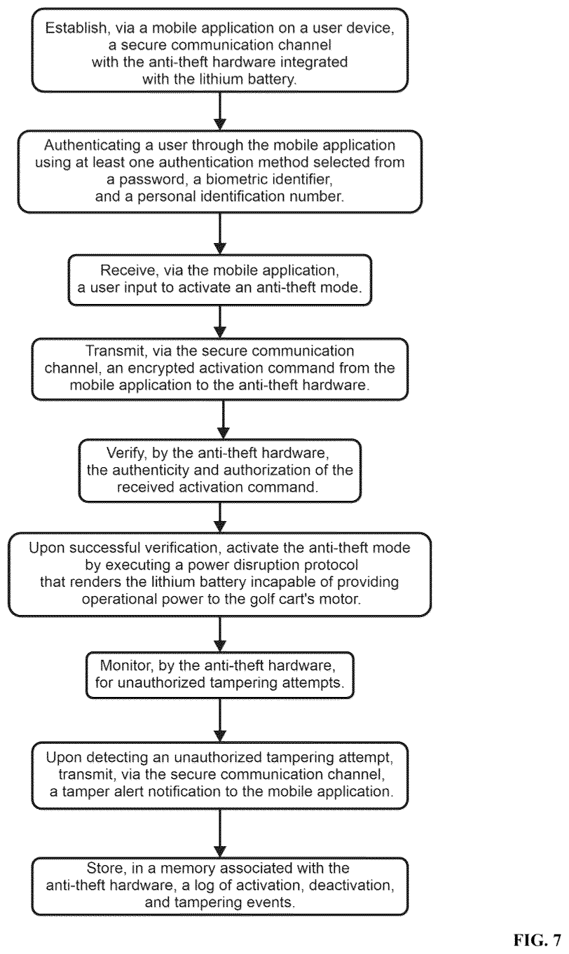

The FIG. 7 illustrates a flowchart depicting the process for activating and operating the anti-theft mode for lithium batteries in golf carts. The process begins at step (70) with establishing a secure communication channel between the mobile application running on the user device and the anti-theft hardware integrated within the lithium battery. This step utilizes industry-standard encryption protocols and secure pairing procedures to prevent man-in-the-middle attacks during communication establishment.

In step (71), the system authenticates the user through the mobile application using one or more authentication methods. The software implements multi-factor authentication by combining knowledge factors (passwords, PINs) with biometric factors (fingerprint, facial recognition) depending on the capabilities of the user device. The authentication algorithms employ salted hashing and secure credential storage practices to protect user authentication data.

Step (72) shows the user interface component receiving input to activate the anti-theft mode, typically through the toggle interface depicted in FIG. 5. The software captures this intent and prepares the appropriate command packet for transmission. In step (73), the mobile application's security module encrypts the activation command using AES-256 encryption and transmits it via the established secure channel to the anti-theft hardware.

Upon receipt, step (74) indicates the verification process performed by the anti-theft hardware's firmware, which validates digital signatures and authentication tokens to confirm command authenticity. The embedded software in the controller executes cryptographic validation routines to prevent replay attacks or command spoofing.

Step (75) represents the execution of the power disruption protocol following successful verification. The firmware initiates the power control module operation, using hardware-level interrupts to safely disconnect power pathways according to programmed sequences that protect circuit integrity.

In steps (76) and (77), the system enters continuous monitoring mode, where the firmware periodically samples sensor inputs to detect tampering attempts, with configurable sensitivity thresholds. Upon detecting abnormal conditions exceeding these thresholds, the software triggers alert generation and transmission procedures, notifying the user's mobile application.

Finally, step (78) shows the data logging functionality, where the system's firmware writes encrypted event records to non-volatile memory, creating a tamper-evident audit trail of all security-relevant events for later forensic analysis if needed.

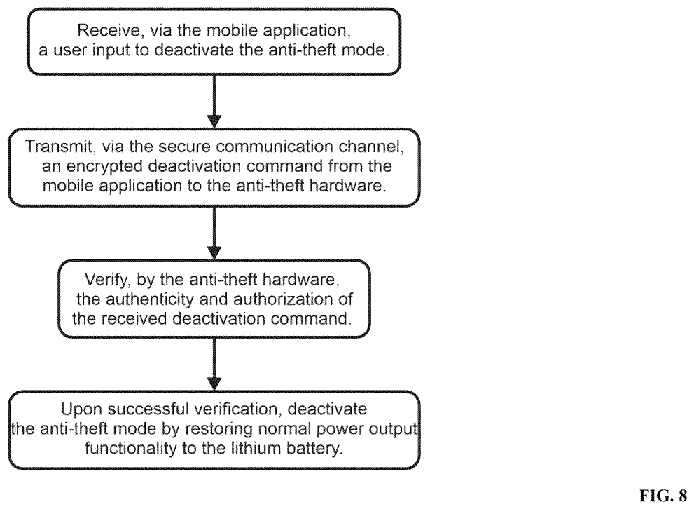

The embodiment of FIG. 8 illustrates the process flowchart for deactivating the anti-theft mode of the lithium battery system. The sequence begins at step (80) where the mobile application's user interface captures the deactivation request when the user toggles the control to the “off” position as shown in FIG. 6. The application software validates the user's session authentication status before proceeding. In step (81), the mobile application's security module constructs a deactivation command packet, encrypts it using the established cryptographic protocols, and transmits it through the secure communication channel to the anti-theft hardware. The software implements packet verification and acknowledgment mechanisms to ensure delivery. Step (82) depicts the critical verification process performed by the anti-theft hardware's firmware, which executes signature validation algorithms and authorization checks against stored credentials to authenticate the deactivation request. Multiple verification layers prevent unauthorized deactivation attempts. Finally, in step (83), upon successful verification, the firmware instructs the power control module to execute the restoration sequence, which systematically re-enables power pathways through controlled switching operations, allowing the lithium battery to resume normal power output to the golf cart's motor while maintaining power stability and protecting circuit components.

The anti-theft system may be implemented with various wireless communication protocols including but not limited to Bluetooth Low Energy, Wi-Fi, cellular networks, or proprietary RF protocols, allowing flexibility in deployment across different environments and use cases.

In some implementations, the power disruption may occur through physical relay switches, while in alternative embodiments, solid-state switching technologies such as MOSFETs or IGBTs may be employed to achieve power interruption with no moving parts for increased reliability.

The authentication mechanisms may extend beyond traditional methods to include voice recognition, retinal scanning, or pattern-based authentication depending on user device capabilities and security requirements for the specific deployment scenario.

Alternative embodiments may incorporate solar charging capabilities that maintain power to the anti-theft circuitry even when the main battery is physically disconnected, ensuring continuous protection during extended storage periods.

The system may optionally include GPS tracking functionality that activates automatically when tampering is detected, providing location data to assist in recovery of stolen batteries or golf carts through integration with mapping services.

In some implementations, the system may include tilt sensors, accelerometers, or vibration detectors as alternative means of detecting tampering attempts, with configurable sensitivity settings to accommodate different usage environments.

Some embodiments may implement a distributed architecture where security processing is divided between the mobile device and the battery controller, while alternative implementations may concentrate all security operations within the battery hardware for standalone protection.

The user interface may be alternatively implemented as a web application, a desktop application, or integrated within existing golf course management software systems to accommodate various customer deployment preferences.

Alternative power control mechanisms may include partial disabling that allows limited movement at reduced speed rather than complete immobilization, providing flexibility in implementing tiered security responses based on risk assessment.

The system may optionally support fleet management features with hierarchical access controls, allowing course managers to monitor and control multiple protected batteries while individual users maintain access only to their assigned carts.

### INDUSTRIAL APPLICATION

This lithium battery anti-theft system has significant industrial applications beyond golf carts. The technology can be implemented in electric forklifts, airport ground support equipment, and warehouse logistics vehicles where lithium batteries represent substantial capital investments. Manufacturing facilities can integrate this system into their fleet management protocols, reducing theft-related downtime and insurance costs. The remote monitoring capability allows centralized security teams to manage large industrial fleets efficiently. Additionally, rental equipment companies can leverage this technology to prevent unauthorized use and track battery assets across multiple job sites, enhancing operational security throughout industrial sectors.

What is claimed is:

1. A system for preventing unauthorized use of a lithium battery in a golf cart, the system comprising:
a lithium battery configured to power a golf cart;
an anti-theft hardware module integrated with the lithium battery and configured to selectively enable or disable power output from the lithium battery;
a mobile application executable on a user device and configured to communicate with the anti-theft hardware module; and
a controller communicatively coupled to the anti-theft hardware module and configured to:
receive, from the mobile application, an activation command to enable an anti-theft mode;
authenticate the activation command;
upon successful authentication, instruct the anti-theft hardware module to disable power output from the lithium battery; and
monitor for tampering attempts and transmit a notification to the mobile application upon detection of a tampering attempt.

2. The system of claim 1 wherein the anti-theft hardware module comprises a switching circuit that interrupts a power path between battery cells and output terminals when the anti-theft mode is enabled and wherein the controller is further configured to receive a deactivation command from the mobile application and upon authentication of the deactivation command instruct the anti-theft hardware module to enable power output from the lithium battery.

3. The system of claim 1 wherein the controller is further configured to establish a secure encrypted communication channel with the mobile application prior to receiving the activation command and wherein the authentication of the activation command comprises verifying user credentials against stored authentication data including at least one biometric verification performed via the mobile application.

4. The system of claim 1 wherein the anti-theft hardware module comprises at least one sensor configured to detect physical tampering with the lithium battery and wherein the controller is further configured to maintain a log of activation events deactivation events and tampering detection events.

5. A method for preventing unauthorized use of a lithium battery in a golf cart, the method comprising:
establishing a communication link between a mobile application on a user device and an anti-theft hardware module integrated with a lithium battery installed in a golf cart;
authenticating a user through the mobile application;
receiving, via the mobile application, a user input to activate an anti-theft mode;
transmitting an activation command from the mobile application to the anti-theft hardware module;
verifying the authenticity of the received activation command;
upon successful verification, activating the anti-theft mode by disabling power output from the lithium battery to the golf cart's motor;
monitoring for unauthorized tampering attempts; and
transmitting an alert notification to the mobile application upon detection of an unauthorized tampering attempt.

6. The method of claim 5 further comprising receiving via the mobile application a user input to deactivate the anti-theft mode transmitting a deactivation command to the anti-theft hardware module and upon verification of the deactivation command restoring power output functionality to the lithium battery.

7. The method of claim 5 wherein establishing the communication link comprises initiating a wireless connection between the user device and the anti-theft hardware module and wherein authenticating the user comprises verifying at least one of a password a personal identification number and a biometric identifier.

8. The method of claim 5 wherein disabling power output comprises actuating an electronic switch that interrupts current flow between battery cells and output terminals and wherein monitoring for unauthorized tampering attempts comprises detecting changes in at least one of voltage current temperature and physical orientation of the lithium battery.

9. The method of claim 5 further comprising encrypting the activation command prior to transmission from the mobile application to the anti-theft hardware module and storing in a memory associated with the anti-theft hardware module a log of activation events deactivation events and tampering detection events.

10. A non-transitory computer-readable medium storing instructions that when executed by at least one processor cause the at least one processor to perform operations for preventing unauthorized use of a lithium battery in a golf cart, the operations comprising:
establishing a communication link between a mobile application executing on a user device and an anti-theft module integrated with a lithium battery installed in a golf cart;
authenticating user credentials received through the mobile application;
processing a command received from the mobile application to toggle an anti-theft mode of the lithium battery;
when the command is to activate the anti-theft mode, transmitting instructions to the anti-theft module to disable power output from the lithium battery;
when the command is to deactivate the anti-theft mode,
transmitting instructions to the anti-theft module to enable power output from the lithium battery;
monitoring sensor data from the anti-theft module to detect tampering attempts; and
generating a notification for display on the mobile application when tampering is detected.

11. The non-transitory computer-readable medium of claim 10 wherein the operations further comprise encrypting communication between the mobile application and the anti-theft module using a secure communication protocol and wherein authenticating user credentials comprises verifying biometric data captured through the user device.

12. The non-transitory computer-readable medium of claim 10 wherein the operations further comprise storing activation deactivation and tampering events in a secure log and displaying on the mobile application a real-time status of the anti-theft mode and battery condition.

13. The non-transitory computer-readable medium of claim 10 wherein the operations further comprise detecting a geographic location of the user device and automatically activating the anti-theft mode when the user device moves beyond a predetermined distance from the golf cart.

14. The non-transitory computer-readable medium of claim 10 wherein the operations further comprise periodically verifying connectivity between the mobile application and the anti-theft module and triggering an alert when connectivity is lost.

15. The system of claim 1 wherein the mobile application is further configured to display real-time status information regarding the anti-theft mode of the lithium battery and wherein the controller implements a geographic boundary function that automatically activates the anti-theft mode when the user device moves beyond a predetermined distance from the lithium battery.
